(19) United States
(12) Patent Application Publication
(10) Pub. No.: US 2012/0304959 A1
(43) Pub. Date: Dec. 6, 2012

(54) LASER SPARK PLUG

(76) Inventors: Martin Weinrotter, Vitoria-Gasteiz (ES); Werner Herden, Gerlingen (DE); Juergen Raimann, Weil Der Stadt (DE); Andreas Letsch, Stuttgart (DE)

(21) Appl. No.: 13/504,860

(22) PCT Filed: Oct. 4, 2010
(86) PCT No.: PCT/EP10/64749

§ 371 Date: Aug. 17, 2012

(30) Foreign Application Priority Data
Nov. 6, 2009 (DE) 102009046472.7

(51) Int. Cl. F02B 19/12

(52) U.S. Cl. 123/260

(57) ABSTRACT

A laser spark plug having an antechamber is designed to irradiate laser radiation, which is guided and/or generated in the laser spark plug on at least two ignition points which are different from one another and are lying in the antechamber. The laser spark plug is designed to irradiate the laser radiation into the antechamber in such a way that a distance between at least one first ignition point and one second ignition point adjoining thereto is larger than a minimum distance between the first and/or the second ignition point(s) and an inner surface of the antechamber.

### BACKGROUND OF THE INVENTION

1. Field of the Invention

The present invention relates to a laser spark plug having an antechamber, the laser spark plug being designed to irradiate, in particular to focus, laser radiation, which is guided and/or generated in the laser spark plug, on at least two ignition points, which are different from one another and are situated in the antechamber.

2. Description of Related Art

A laser spark plug of the above-mentioned type is described in published French patent application document FR 2 873 763 A1.

### BRIEF SUMMARY OF THE INVENTION

It is an object of the present invention to refine a laser spark plug of the type mentioned at the outset in such a way that an improved, in particular more uniform and rapid, combustion is made possible in the antechamber.

This object is achieved according to the present invention for the laser spark plug of the type mentioned at the outset in that the laser spark plug is designed to irradiate the laser radiation into the antechamber in such a way that a distance between at least one first ignition point and one second ignition point adjoining thereto is larger than a minimum distance between the first and/or the second ignition point and an inner surface of the antechamber.

The embodiment according to the present invention of the laser spark plug advantageously allows for a uniform and efficient combustion of an air/fuel mixture present in the antechamber, since the flame cores, which are generated at the individual ignition points under adherence to the distance criterion according to the present invention, or the flame fronts developing therefrom may propagate unimpededly for the longest possible time until they reach the inner surface of the antechamber or an adjoining flame front.

The principle according to the present invention advantageously allows for a maximum pressure increase during the combustion in the antechamber, whereby particularly high-energy spark torches may exit the antechamber via overflow passages implementing a fluid connection to a main combustion chamber.

In one particularly advantageous specific embodiment of the laser spark plug according to the present invention, it is provided that the distance between the adjoining ignition points accounts for at least 120 percent, preferably at least approximately 160 percent, of the minimum distance between the first and/or the second ignition point(s) and the inner surface of the antechamber, thus resulting in a particularly efficient combustion according to the tests of the applicant.

Particularly advantageously, it may be provided according to another variant of the present invention that a distance between all adjoining ignition points accounts for at least 120 percent, preferably at least approximately 160 percent, of the minimum distance between an ignition point and the inner surface of the antechamber, i.e., the principle according to the present invention is also transferred to all the ignition points in the event that there are more than two ignition points. Furthermore, it is particularly advantageous in this case if the ignition points are distributed as uniformly as possible in the antechamber, by taking into account the individual boundary conditions according to the present invention with regard to the distance of adjoining ignition points and their distance to the inner surface of the antechamber.

In another very advantageous specific embodiment of the laser spark plug according to the present invention, it is provided that a minimum distance between an ignition point and the inner surface of the antechamber ranges between approximately 10 percent and approximately 40 percent of a maximum expansion of an interior of the antechamber, in the case of an essentially at least partially spherical or elliptical antechamber, in particular between approximately 10 percent and approximately 40 percent of a radius of the antechamber. This configuration is particularly advantageous for systems having between two and approximately eight ignition points.

In another very advantageous variant of the present invention, in which the antechamber is at least partially essentially spherical or elliptical in shape, it is provided that the distance between the first ignition point and the second ignition point is approximately twice as large as a minimum distance between the first and/or the second ignition point(s) and the inner surface of the antechamber.

In general, it may be provided according to the present invention that a mean distance between adjoining ignition points is larger than a mean distance between the ignition points and the inner surface of the antechamber. The mean distance between adjoining ignition points may be ascertained as a mean value, for example, via the particular distances between adjoining ignition points. The same applies to the ascertainment of the mean distance between the ignition points and the inner surface of the antechamber, only one minimum distance between the particular ignition point and the inner surface being advantageously considered, in each case.

According to one preferred specific embodiment, the multiple ignition points in the antechamber of the laser spark plug may be set according to the present invention with the aid of an optical element, which focuses the laser radiation on the various ignition points.

According to another variant of the present invention, the optical element may be a focusing optical system having multiple focal lengths, the focusing optical system having at least two focusing areas which are situated essentially concentrically to one another or next to one another and each of which having a different focal length. A focusing optical system of this type may, for example, be implemented by a lens-shaped optical body whose surfaces have sectionally appropriate, in particular different, curvature properties. Alternatively or additionally to the lens system, (concave) mirrors may be used to implement the position of the ignition points provided according to the present invention.

Another very advantageous specific embodiment of the laser spark plug according to the present invention provides that the laser spark plug is designed to irradiate the laser radiation into the antechamber in such a way that a Rayleigh range of the irradiated laser radiation accounts for at least approximately 10 percent, preferably at least approximately 30 percent, of a maximum expansion of an interior of the antechamber.

According to tests of the applicant, a configuration of this type may cause a sequence of multiple consecutive ignition points, also referred to as a spark chain, along the optical axis of the laser spark plug in the antechamber, which also makes a fast and efficient combustion possible. To obtain a spark chain of this type, in particular a long-focal-length focusing optical system is used, which accordingly focuses the laser radiation in the antechamber.

### BRIEF DESCRIPTION OF THE DRAWINGS

FIG. 1 shows an end section facing the combustion chamber of the laser spark plug according to the present invention in a partial cross section in a first specific embodiment.

FIGS. 2, 3, 4 each show different antechamber configurations of other specific embodiments of the laser spark plug according to the present invention.

FIGS. 5, 6, 7 each show an end section facing the combustion chamber of other specific embodiments of the laser spark plug according to the present invention.

FIG. 8 shows variations of the operating variables of the laser spark plug according to the present invention plotted across a beam axis of the laser spark plug.

FIG. 9 schematically shows a partial cross section of another specific embodiment of the laser spark plug according to the present invention.

FIGS. 10a, 10b, 11a, 11b show various specific embodiments of optical elements for use in the laser spark plug according to the present invention.

### DETAILED DESCRIPTION OF THE INVENTION

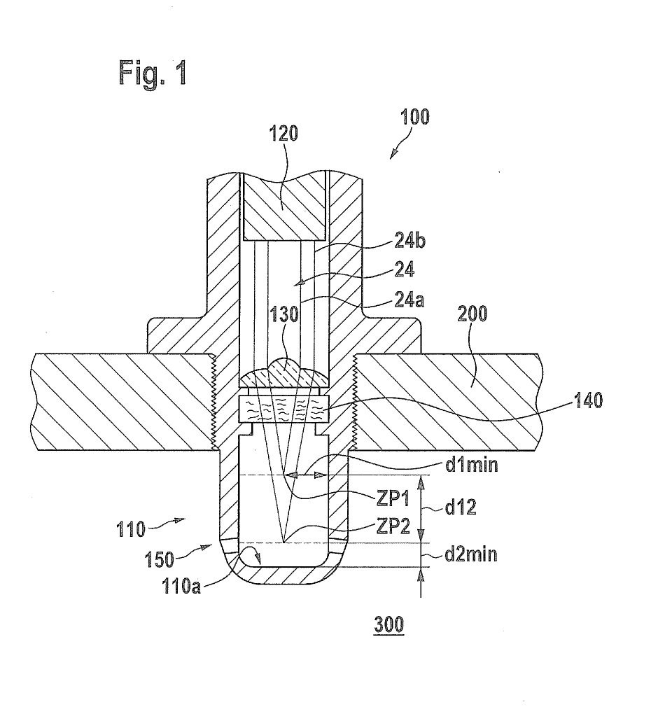

FIG. 1 shows an end section facing the combustion chamber of a laser spark plug 100 according to the present invention in a first specific embodiment. Laser spark plug 100 has an antechamber 110. FIG. 1 shows laser spark plug 100 installed in a cylinder head 200 of an internal combustion engine, antechamber 110 of laser spark plug 100 protruding into combustion chamber 300 of a cylinder of the internal combustion engine. The internal combustion engine may, for example, be a stationary large gas-powered engine or also an internal combustion engine of a motor vehicle.

Laser spark plug 100 has an integrated laser device 120 which may be a laser active solid having a passive Q-switch which generates highly energetic laser ignition pulses 24 in a manner known per se when pump radiation is appropriately applied.

Laser device 120 radiates laser radiation 24 on an optical element 130 which is used, inter alia, to focus laser radiation 24 in a manner to be described below in greater detail.

In the present case, optical element 130 is designed in such a way that it focuses laser radiation 24 on a total of two ignition points ZP1, ZP2, which are situated in antechamber 110 and are different from one another.

In ignition points ZP1, ZP2, a flame core is generated during the laser ignition in a manner known per se, the flame core propagating approximately spherically, while forming a corresponding flame front, as a function of the present air/fuel mixture; non-zero flow speeds in antechamber 110 are disregarded.

In the process, so called spark torches, which ignite an air/fuel mixture present in combustion chamber 300, are pressed out of antechamber 110 into combustion chamber 300 through overflow passages 150 which create a fluid connection between the interior of antechamber 110 and combustion chamber 300.

It is provided according to the present invention that laser spark plug 100 is designed to irradiate laser radiation 24 into antechamber 110 in such a way that a distance d12 between first ignition point ZP1 and second ignition point ZP2 adjoining thereto is larger than a minimum distance d2min between second ignition point ZP2 and an inner surface 110a of antechamber 110.

Particularly preferably, an appropriate minimum distance d1min between first ignition point ZP1 and inner surface 110a is also smaller than distance d12 between ignition points ZP1, ZP2.

The configuration according to the present invention of ignition points ZP1, ZP2 in antechamber 110 advantageously ensures that an efficient and rapid combustion of the air/fuel mixture present in antechamber 110 takes place, thus implementing a maximum excess pressure in antechamber 110. Accordingly, the laser ignition according to the present invention in antechamber 110 results in highly energetic spark torches which allow the mixture present in combustion chamber 300 to be reliably ignited.

The interior of antechamber 110 is separated from an interior of laser spark plug 100 by a combustion chamber window 140 which is optically downstream from focusing optical system 130 with regard to the primary direction of propagation of laser radiation 24.

Although a laser device 120 for generating laser radiation is provided directly in laser spark plug 100, the principle according to the present invention of the configuration of ignition points ZP1, ZP2 in antechamber 110 may also be used for laser spark plugs which are not designed for local generation of laser ignition pulses 24, but rather irradiate laser ignition pulses 24, generated by a remotely situated source, into antechamber 110.

In the variant according to the present invention shown in FIG. 1, optical element 130 has the function of a focusing lens, two focusing areas, which are situated essentially concentrically to one another and have different focal lengths, being provided as is apparent from FIG. 1. In a radially inner area, optical element 130, for example, has a first curvature radius or a generally curved surface having first refraction properties, while a radially outer area has a curvature radius different therefrom or a generally curved surface having second refraction properties different from the first refraction properties.

Consequently, core beam 24a of laser ignition pulse 24 is focused on first ignition point ZP1, while marginal beam 24b of laser ignition pulse 24 is focused on second ignition point ZP2 different therefrom.

Although it is not necessary for the function of the principle according to the present invention, laser spark plug 100 is designed, in particular in antechambers 110 having a rotation-symmetric geometry, in such a way that laser radiation 24 focuses on ignition points ZP1, ZP2 which lie on or approximately in the area of an optical axis of laser spark plug 100.

The configuration according to the present invention of ignition points ZP1, ZP2 in the interior of antechamber 110 advantageously ensures that the flame fronts emanating from ignition points ZP1, ZP2 may propagate unimpededly in the interior of antechamber 110 for the longest possible time starting from the laser ignition, resulting in the desired excess pressure in antechamber 110 as previously described.

In another preferred specific embodiment, laser radiation is essentially simultaneously applied to the two ignition points ZP1, ZP2. Depending on the embodiment of laser device 26, it is possible for a time delay to be provided between the irradiation of the laser ignition pulses on different ignition points ZP1, ZP2.

A particular advantage of the present invention is that none of the flame fronts emanating from ignition points ZP1, ZP2 reaches inner surface 110a of antechamber 110 or an adjoining flame front unnecessarily prematurely; this prevents an efficient burn-through of the antechamber volume. In contrast, the laser ignition according to the present invention makes an efficient combustion in antechamber 110 and thus the generation of particularly high-energy spark torches possible which exit into combustion chamber 300 and reliably ignite the mixture which is present there.

In one particularly advantageous specific embodiment of the laser spark plug 100 according to the present invention, it is provided that distance d12 between adjoining ignition points ZP1, ZP2 accounts for at least 120 percent, preferably at least approximately 160 percent, of minimum distance d2min between second ignition point ZP2 and inner surface 110a of antechamber 110.

If first ignition point ZP1 is closer to inner surface 110a of antechamber 110 than second ignition point ZP2, distance criterion according to the present invention d12>=d2min or preferably d12>=1.6*d2min is to be used accordingly for the relation between ignition point distance d12 and minimum distance d1min between ignition point ZP1 and inner surface 110a of antechamber 110.

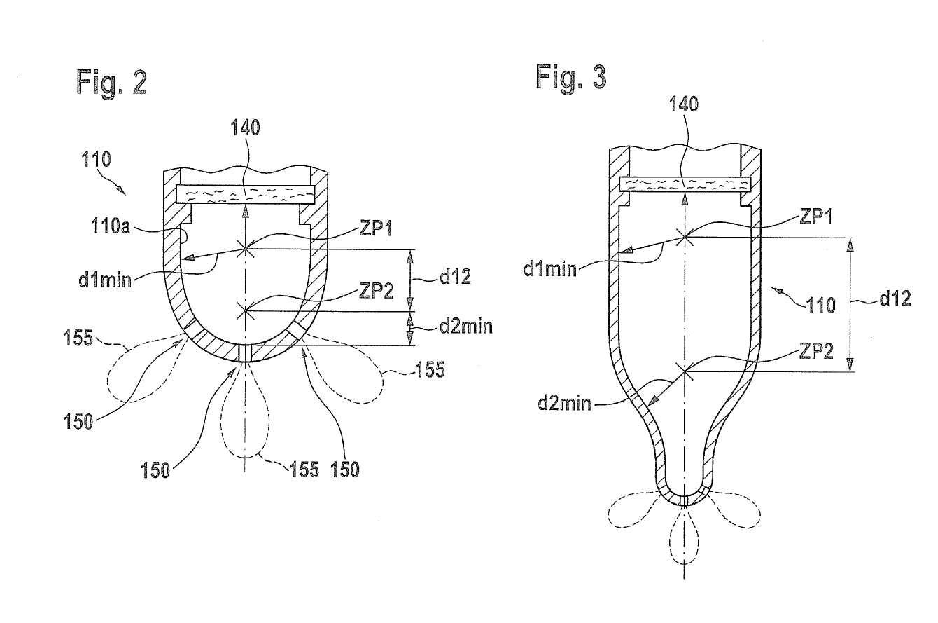

FIG. 2 shows another variant of the present invention whose antechamber configuration differs from the system described with reference to FIG. 1.

Antechamber 110 according to FIG. 2, which is essentially at least partially approximately spherical or elliptical in shape, is in turn separated from the rest of the interior of laser spark plug 100 (not shown in FIG. 2) by a combustion chamber window 140.

According to the present invention, laser spark plug 100 or its focusing optical system (not shown in FIG. 2) is designed in such a way that laser radiation 24 (FIG. 1) generated in laser spark plug 100 is focused on ignition points ZP1, ZP2 apparent from FIG. 2.

In addition to the primary distance criterion according to the present invention

d12>=d1min and/or d12>=d2min

minimum distance d1min between first ignition point ZP1 and inner surface 110a of antechamber 110 is selected here in such a way that it corresponds to approximately 25 percent of a maximum length expansion of the interior of antechamber 110 which extends in the vertical direction in FIG. 2.

Tests of the applicant have shown that this configuration according to the present invention results in a particularly efficient combustion in antechamber 110, in particular if antechambers 110 are essentially at least partially spherical or elliptical in shape, and thus promotes the creation of high-energy spark torches 155.

FIG. 3 shows another specific embodiment of the present invention in which antechamber 110 is essentially cylindrical in shape.

Implementing distance condition d12>=d1min, d2min according to the present invention in an antechamber geometry of this type is advantageous with respect to a rapid and efficient combustion of the air/fuel mixture present in antechamber 110.

FIG. 4 shows another variant of the present invention in which antechamber 110 has an essentially elliptical basic shape. In contrast to the specific embodiments of the laser spark plug according to the present invention described with reference to FIGS. 1 through 3, the configuration illustrated in FIG. 4 has a total of three ignition points ZP1, ZP2, ZP3, of which two ignition points ZP1 and ZP3 lie outside of the optical axis of laser spark plug 100, in particular relatively close to the area of an inner surface 110a of antechamber 110.

This is based on the fact that the tests of the applicant showed that when antechamber 110 is fed with the air/fuel mixture flowing in from combustion chamber 300 via overflow passages 150a, 150b, eddies are created which result in different flow speeds of the mixture present in antechamber 110. In particular, overflow passages 150a, 150b may be advantageously situated relative to one another in such a way that partial flows 151a, 151b flowing in through the overflow passages superimpose on one another with respect to their flow directions and speeds in such a way that particularly high flow speeds result in the area of inner wall 110a of antechamber 110. For this purpose, the longitudinal axis of overflow passages 150a, 150b is situated in particular tangentially to the optical axis or the longitudinal axis of antechamber 110 and not radially.

For the above-described configuration of FIG. 4, it is advantageous if at least one, preferably two, ignition points ZP1, ZP3 is/are situated in the area of high flow speeds in order to allow the air/fuel mixture present in antechamber 110 to be reliably ignited. Additionally, the other ignition point ZP2 situated centrally on the optical axis of laser spark plug 100 causes a reliable ignition of the air/fuel mixture present in antechamber 110 even in those areas in which the flow speed has relatively low values.

Ignition points ZP1, ZP2, ZP3 described above with reference to FIG. 4 in turn advantageously meet criteria d12>=d1min, d23>=d3min according to the present invention, particular ignition point distances d12, d23 advantageously even exceeding particular minimum distances d1min, d3min of considered ignition points ZP1, ZP3 by more than approximately 160 percent.

Combining the distance criteria according to the present invention for the configuration of ignition points ZP1, ZP2, ZP3 inside antechamber 110 by taking into account the flow speeds to be expected in antechamber 110 yields particularly good results with regard to an efficient and rapid combustion in antechamber 110.

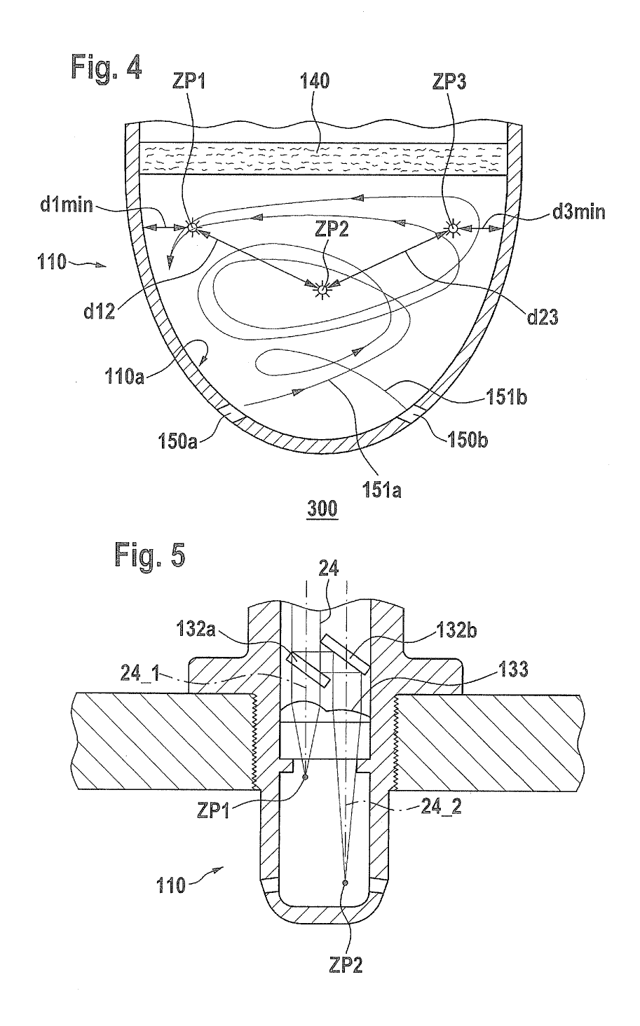

FIG. 5 shows another specific embodiment of a laser spark plug 100 according to the present invention in which a beam splitter is implemented with the aid of two mirrors 132a, 132b, one of which being partially reflective, to irradiate laser ignition pulses 24 on two different ignition points ZP1, ZP2.

A focusing optical system 133 is optically downstream from beam splitter 132a, 132b, some portions of the focusing optical system having different refraction properties in such a way that a partial beam 24_1 passing through mirror 132a is focused on first ignition point ZP1 and a partial beam 242 reflected by mirror 132b is focused on second ignition point ZP2.

Although ignition points ZP1, ZP2 are outside the optical axis of laser spark plug 100 in the above-described specific embodiment according to FIG. 5, the distance criterion according to the present invention is met again in such a way that the distance between ignition points ZP1, ZP2 is considerably larger than a minimum distance between the two ignition points ZP1, ZP2 and a particular section of an inner surface 110a (FIG. 1) of antechamber 110 in the present case.

FIG. 6 shows another specific embodiment of a laser spark plug 100 according to the present invention in which a diffractive optical system 135 is used instead of a focusing optical system, in order to split up laser ignition pulse 24 into multiple partial beams. At the same time, diffractive optical system 135 may be advantageously designed in such a way that it focuses the two partial beams on appropriate ignition points ZP1, ZP2. Alternatively or additionally, the partial beams may also be focused through combustion chamber window 140 which is optically downstream from diffractive optical system 135.

FIG. 7 shows another specific embodiment of a laser spark plug according to the present invention in which the focusing optical system (not illustrated above) is designed, in particular as a long-focal-length focusing lens, in such a way that a Rayleigh length of laser radiation 24 irradiated into antechamber 110 accounts for at least approximately 10 percent, preferably at least approximately 30 percent, of a maximum expansion L of the interior of antechamber 110. For example, the Rayleigh length may be selected in a range between approximately 0.4 cm and approximately 1.2 cm.

For this reason, the implementation of a so-called spark chain is advantageously ensured which arises in the present case in that laser radiation 24 irradiated into antechamber 110 via an appropriate length range within antechamber 110 has a sufficiently high electric field intensity or optical power density. This means that the air/fuel mixture present in antechamber 110 may be ignited essentially simultaneously over the entire Rayleigh length, for example.

Although the specific embodiment of the present invention described above with reference to FIG. 7 does not necessarily meet the distance criterion which the present invention is primarily based on, a particularly uniform and rapid combustion takes place in antechamber 110 when the Rayleigh length is selected to be relatively large according to the present invention.

Another option according to the present invention to implement two laterally offset ignition points is to use a purely astigmatic laser beam 24 and/or an astigmatic optical element, i.e., an element having a different refractive power in different spatial directions.

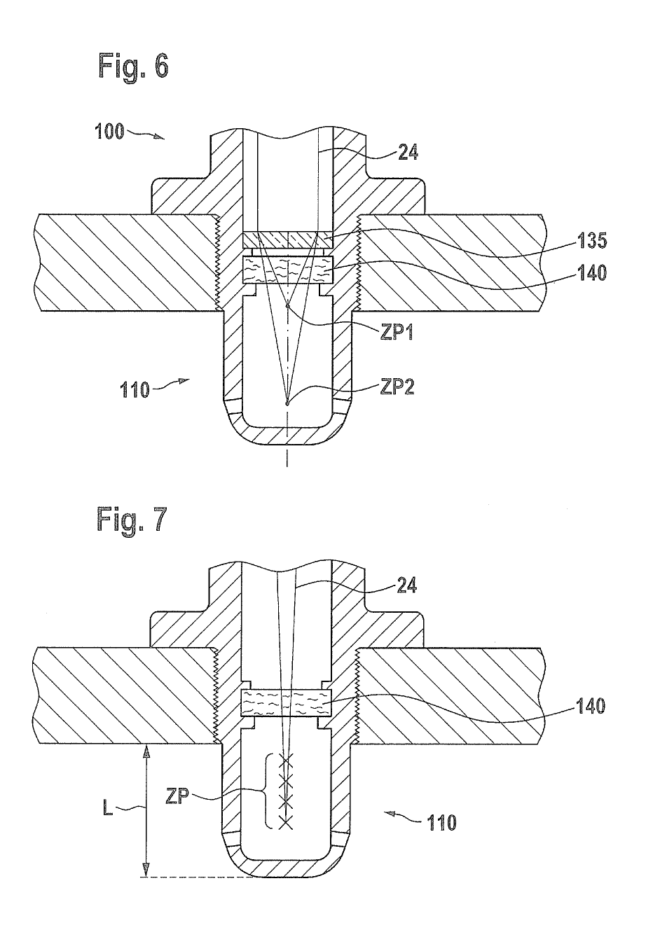

FIG. 8 shows in this regard the variation of a beam diameter of laser radiation 24 in planes x, y, which are perpendicular to one another, along a z coordinate which corresponds to the direction of laser radiation 24.

Reference symbol SDx identifies in the present case the beam diameter of laser radiation 24 in a first plane x, and reference symbol SDy identifies the beam diameter of laser radiation 24 in a second plane y which is orthogonal to first plane x.

As is apparent from FIG. 8, positions z1, z2 of minimum beam diameter fall apart along beam coordinate z so that power density S, which is logarithmically plotted in the diagram from FIG. 8, accordingly has two local maxima at positions z1, z2.

Positions z1, z2 from the diagram according to FIG. 8 correspond to a first and a second ignition point ZP1, ZP2 in antechamber 110.

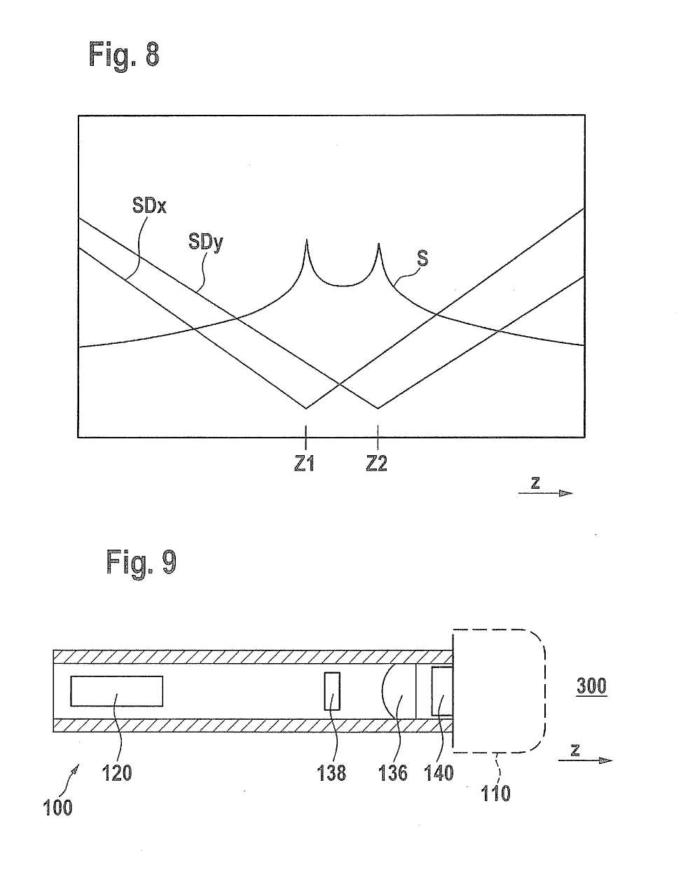

FIG. 9 shows another specific embodiment of a laser spark plug 100 according to the present invention in which a focusing first element 136, which is designed as an asphere, for example, is provided.

A first option according to the present invention, to generate beam diameter SDx, SDy of the laser radiation generated with the aid of laser device 120 according to FIG. 8, is based on providing a cylindrical lens 138 which is inserted into the beam passage of laser spark plug 100, in particular between laser device 120 and focusing optical system 136.

Another option for modification according to the present invention of beam diameter SDx, SDy, (cf. FIG. 8) is to provide a combustion chamber window 140 whose first optical surface is designed in the form of a cylindrical area, for example. This means that combustion chamber window 140 has the shape of a cylindrical lens.

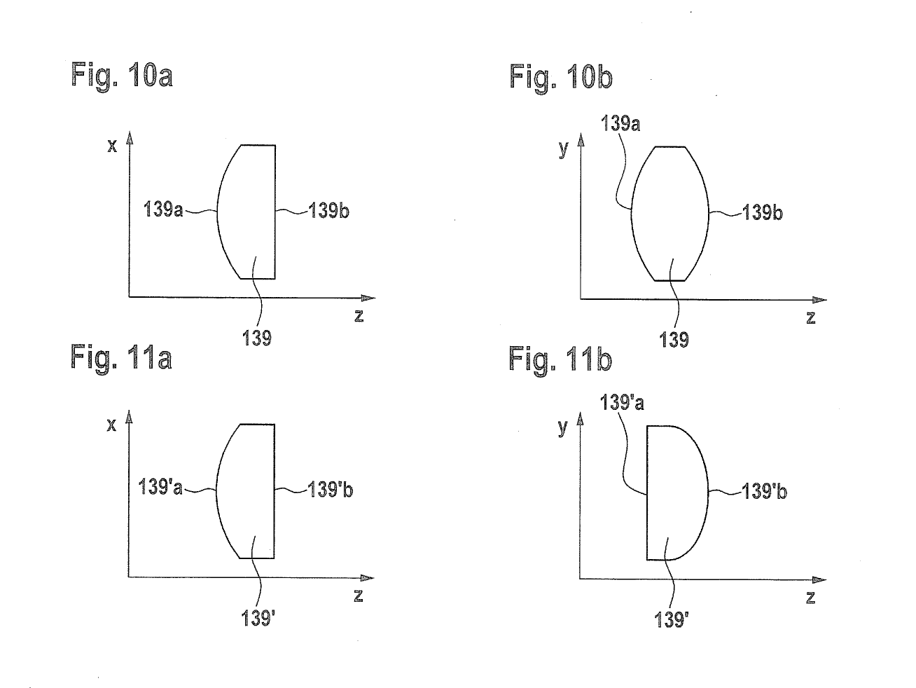

It is likewise possible to use an optical element 139 (cf. FIG. 10a) which is designed in the form of a sphere or asphere on a first optically active side 139a, and which is designed in the form of a cylinder on opposite optical side 139b.

FIGS. 10a, 10b show corresponding sections through an optical element 139 of this type in the x, z and y planes.

In the event of sufficient stability, optical element 139 may also assume the function of a combustion chamber window 140 so that the focusing, the generation of two or multiple ignition points, and the function of a combustion chamber window may be implemented at the same time by element 139.

Furthermore, it is possible to use an optical element 139′ (cf. FIG. 11a), which is designed in the form of a cylinder or also in the form of a sphere or asphere, on a first optically active surface 139′a, and which has a second cylindrical area, which implements a different focal length than the geometry of first optical surface 139′a, on an opposite second optical surface 139′b. This may, for example, be achieved in that the particular areas 139′a, 139′b (cf. FIG. 11a, FIG. 11b) have different curvature parameters and/or in that the axes of symmetry of the particular surfaces are situated perpendicularly relative to one another.

Another option for generating multiple different ignition points is to use a purely astigmatic laser beam having different waist positions. A laser beam of this type automatically generates in combination with a rotation-symmetric optical system two ignition points. An astigmatic laser beam may, for example, be emitted by a solid-state laser which has an appropriate asymmetry. The asymmetry may be generated either by an appropriate asymmetric pumping profile, e.g., in the case of a Q-switched laser, or by impressing a temperature and/or mechanical tension profile. This may be impressed on the solid-state laser through an asymmetric coupling to heat sources or sinks, for example.

Alternatively or additionally, one or multiple cylindrical areas may be used as resonator mirrors for the laser resonator, in order to generate an astigmatic laser beam. An astigmatic laser beam generated in the above-described manner may preferably also be combined with the other above-described measures according to the present invention.

It is generally advantageous to use the principle according to the present invention when taking into account the flow conditions prevailing in antechamber 110, the ignition points being selected particularly advantageously in such a way that all the flame fronts emanating therefrom fill the antechamber volume as quickly as possible. This effect is achieved according to the present invention in particular when the ignition points are situated in the antechamber in such a way that the flame fronts propagating away from them reach the inner wall of the antechamber or adjoining flame fronts as late as possible.

1-10. (canceled)

11. A laser spark plug, comprising:
an antechamber containing at least two different ignition points;
wherein laser radiation which is at least one of guided and generated in the laser spark plug is focused on the at least two different ignition points;
wherein the laser spark plug is configured to irradiate the laser radiation into the antechamber in such a way that a distance between the at least two ignition points is larger than a predefined minimum distance between at least one of the two ignition points and an inner surface of the antechamber.

12. The laser spark plug as recited in claim 11, wherein the distance between the at least two ignition points accounts for at least 120 percent of the minimum distance between the at least one of the two ignition points and the inner surface of the antechamber.

13. The laser spark plug as recited in claim 11, wherein at least three ignition points are provided in the antechamber, and wherein a distance between any two adjacent ignition points accounts for at least 120 percent of the minimum distance between the at least one of the ignition points and the inner surface of the antechamber.

14. The laser spark plug as recited in claim 11, wherein the minimum distance between the at least one of the ignition points and the inner surface of the antechamber accounts for approximately 10 percent to approximately 40 percent of a maximum expanse of an interior of the antechamber.

15. The laser spark plug as recited in claim 11, wherein the antechamber is one of at least partially spherical or at least partially elliptical in shape, and the distance between the at least two ignition points is approximately twice as large as the predefined minimum distance between at least one of the two ignition points and the inner surface of the antechamber.

16. The laser spark plug as recited in claim 13, wherein a mean distance between adjoining ignition points is larger than a mean distance between the ignition points and the inner surface of the antechamber.

17. The laser spark plug as recited in claim 12, further comprising:
an optical element which focuses the laser radiation (24) on the at least two different ignition points.

18. The laser spark plug as recited in claim 17, wherein the optical element is a focusing optical system having multiple focal lengths.

19. The laser spark plug as recited in claim 18, wherein the focusing optical system has at least two focusing areas situated one of (i) essentially concentrically to one another or (ii) adjacent to one another, and wherein each focusing area has a different focal length.

20. The laser spark plug as recited in claim 14, wherein the laser spark plug is configured to irradiate the laser radiation into the antechamber in such a way that a Rayleigh range of the irradiated laser radiation accounts for at least approximately 30 percent of the maximum expanse of the interior of the antechamber.
